(19) United States
(12) Patent Application Publication
(10) Pub. No.: US 2019/0219865 A1
(43) Pub. Date: Jul. 18, 2019

(54) BPS ARRAY SUBSTRATE AND MANUFACTURING METHOD THEREOF

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Chengzhong YU, Shenzhen, Guangdong (CN)

(21) Appl. No.: 15/578,163

(22) PCT Filed: Nov. 15, 2017
(86) PCT No.: PCT/CN2017/110979

§ 371 Date: Nov. 29, 2017

(30) Foreign Application Priority Data
Sep. 26, 2017 (CN) 201710884327.3

(51) Int. Cl. G02F 1/1335; G02F 1/1339; G02F 1/1368

(52) U.S. Cl. CPC G02F 1/133514; G02F 1/1368; G02F 1/133512; G02F 1/13392

(57) ABSTRACT

The manufacturing method of the BPS array substrate allows a black matrix, main photo spacers, and sub photo spacers to be all arranged on an array substrate with the same manufacturing process, wherein thicknesses of color resist units are used to achieve a height difference between the main photo spacer and the black matrix and the thicknesses of the color resist units are also used, in combination with controlling of light transmission rate of the mask, to achieve a height difference between the sub photo spacer and the black matrix. The area of the black light-shielding film layer that corresponds to and forms the black matrix corresponds to an area of a mask that is a full light transmission area during an exposure process so as to be irradiated with a sufficient amount of ultraviolet light during exposure to undergo complete crosslinking reaction.

### RELATED APPLICATIONS

The present application is a National Phase of International Application Number PCT/CN2017/110979, filed Nov. 15, 2017, and claims the priority of China Application No. 201710884327.3, filed Sep. 26, 2017.

### BACKGROUND OF THE INVENTION

### 1. Field of the Invention

The present invention relates to the field of display technology, and more particularly to a black-photo-spacer (BPS) array substrate and a manufacturing method thereof.

### 2. The Related Arts

With the progress of the display technology, flat panel display devices, such as liquid crystal displays (LCDs), due to various advantages, such as high image quality, low power consumption, thin device body, and wide range of applications, have become the mainstream of the display devices and have been widely used in all sorts of consumer electronic products, including mobile phones, televisions, personal digital assistants (PDAs), digital cameras, notebook computers, and desktop computers.

Most of the liquid crystal display devices that are currently available in the market are backlighting LCDs, which comprise a backlight module, a liquid crystal panel coupled to the backlight module, and a bezel that fixes the liquid crystal panel and the backlight module. The working principle of the liquid crystal panel is that with liquid crystal molecules disposed between two parallel glass substrates and multiple vertical and horizontal tiny conductive wires arranged between the two glass substrates, electricity is applied to control direction change of the liquid crystal molecules for refracting out light emitting from the backlight module to generate an image.

The liquid crystal display panel is made up of a color filter (CF) substrate, a thin-film transistor (TFT) substrate, liquid crystal (LC) interposed between the CF substrate and the TFT substrate, and sealant and is generally manufactured with a process involving an anterior stage of array engineering (for thin film, photolithography, etching, and film peeling), an intermediate stage of cell engineering (for lamination of the TFT substrate and the CF substrate), and a posterior stage of module assembly (for combining a drive integrated circuit (IC) and a printed circuit board). Among these stages, the anterior stage of array engineering generally involves the formation of the TFT substrate for controlling the movement of liquid crystal molecules; the intermediate stage of cell engineering generally involves filling liquid crystal between the TFT substrate and the CF substrate; and the posterior stage of module assembly generally involves the combination of the drive IC and the printed circuit board for driving the liquid crystal molecules to rotate for displaying images.

It is a forever-lasting challenge of technique developers to make a liquid crystal display panel that provide a better effect of image viewing (such as a curved display) and to reduce the manufacturing cost of the liquid crystal display panel. Black-photo-spacer (BPS) technology is a technique that makes a black matrix (BM) and photo spacers (PSs) with the same material in the same process on an array substrate. A traditional BPS technique comprises applying multi-tone mask based operations to carry out exposure of the BPS material, wherein the multi-tone mask is a mask that possesses three different light transmission rates so that the three different light transmission rates make three areas of different film thicknesses on the PBS material to respectively function as main PS, sub PS, and BM. Among the three light transmission rates (Tr) of the multi-tone mask, the light transmission rate of the area that forms the main PS is the greatest one and is generally 100%; the light transmission rate of the area that forms the sub PS is smaller and is generally 20%-40%; and the light transmission rate of the area that forms the sub BM is the smallest and is generally 10%-30%.

FIG. 1 is a schematic view illustrating different levels of crosslinking reaction of the BPS material subjected to exposure with different light transmission rates. It can be seen from FIG. 1 that during a process of exposure of the BPS material with a multi-tone mask, the BPS material is irradiated with ultraviolet (UV) light of different doses and is caused with different levels of crosslinking reaction. For an area corresponding to Tr1=0%, since there is no irradiation of UV light during the exposure process, the BPS material does not undergo any crosslinking reaction; for an area corresponding to Tr3=100%, since there is sufficient illustration energy of UV light during the exposure process, crosslinking reaction is caused down to a deeper portion of the BPS material; and for an area corresponding to Tr2=0%-100%, since there is partial irradiation of UV light, crosslinking reaction occurs partly, meaning crosslinking reaction occurs in a shallower, upper layer.

FIG. 2 is a schematic view illustrating dissolution rates of the BPS material in a development process after being exposure with different light transmission rates. It can be seen from FIG. 2 that for the area corresponding to Tr1=0%, since it is not irradiated with UV light during the exposure process, the BPS material undergoes no crosslinking reaction and film thickness and the development time show a linear relationship, meaning the film thickness reduces, in a consistent way, with the extension of time until it disappears, to which the time point corresponds is referred to as “Break Time”; for the area corresponding to Tr3=100%, it is irradiated with sufficient amount of UV light energy during the exposure process, the BPS material undergoes crosslinking reaction at a deep layer so that the resistance against dissolution is strong and the film thickness is hardly affected during the entirety of the development process; and for the area corresponding to Tr2=0%-100%, it is partly irradiated with UV light and undergoes partly crosslinking reaction so that the crosslinking reaction occurs at a shallow, upper layer and the upper layer is dissolved with a developer agent, but at a slower rate, and once the upper layer is completely dissolved, the lower layer starts to dissolve at a dissolution rate that is similar to that of the area corresponding to Tr1, meaning two dissolution rates appear during the development process.

For the state-of-the-art BPS technology, the area (Tr3=100%) corresponding to main PS is irradiated with an sufficient amount of UV light and the crosslinking reaction is complete so that the film thickness is generally not varied; and for the area (Tr2=0%-100%) corresponding to sub PS and BM, the amount of irradiation of UV light is not sufficient and the crosslinking reaction is not complete so that influences caused by all sorts of factors of the surrounding environment during the development process may readily show up, leading to poor consistency of film thickness of sub PS and BM.

### SUMMARY OF THE INVENTION

Objectives of the present invention are to provide a manufacturing method of a black-photo-spacer (BPS) array substrate, which allows heights of main photo spacers and sub spacers to be easily controllable and ensures improved consistency of film thickness of a black matrix.

Objectives of the present invention are also to provide a BPS array substrate, in which heights of main photo spacers and sub photo spacers are easily controllable and the consistency of film thickness of a black matrix is improved.

To achieve the above objectives, the present invention provides a manufacturing method of a BPS array substrate, which comprises the following steps:

Step S1: providing a backing substrate, making a thin-film transistor array layer on the backing substrate, and forming a protective layer on the backing substrate to cover the thin-film transistor array layer;

Step S2: forming a color resist layer on the protective layer, wherein the color resist layer comprises a plurality of color resist units arranged in an array and each of the color resist units comprises a first pixel zone, a second pixel zone, and a connection zone arranged between the first pixel zone and the second pixel zone;

Step S3: forming an organic insulation layer on the protective layer to cover the color resist layer and depositing a black light-shielding film layer on the organic insulation layer,

wherein the black light-shielding film layer is formed to define multiple main photo spacer patterns corresponding to and located above the connection zones of multiple ones of the color resist units, multiple sub photo spacer patterns corresponding to and located above the connection zones of multiple ones of the color resist units, and a black matrix pattern corresponding to spacing areas between the plurality of color resist units and a circumferential area of the plurality of color resist units;

Step S4: subjecting the black light-shielding film layer to ultraviolet light exposure with one mask, wherein the mask comprises partial light transmission areas corresponding to the multiple sub photo spacer patterns and full light transmission areas corresponding to the multiple main photo spacer patterns and the black matrix pattern; and

Step S5: subjecting the black light-shielding film layer to development to form multiple main photo spacers corresponding to and located above the connection zones of multiple ones of the color resist units, multiple sub photo spacers corresponding to and located above the connection zones of multiple ones of the color resist units, and a black matrix corresponding to and located above the spacing areas between the plurality of color resist units and the circumferential area of the plurality of color resist units,

wherein the main photo spacers have a height that is greater than a height of the sub photo spacers and the height of the sub photo spacers is greater than a height of the black matrix.

The connection zones have width that is smaller than widths of the first pixel zones and the second pixel zones, and a height difference between the main photo spacers and the black matrix is a thickness of the connection zones of the color resist units.

A height difference between the main photo spacers and the sub photo spacers is 0.3 μm-0.8 μm and the black light-shielding film layer is formed of a material that comprises a negative photoresist material.

The partial light transmission areas have a light transmission rate of 20%-40% and the full light transmission areas have a light transmission rate of 100%.

The thin-film transistor array layer comprises a gate electrode arranged on the backing substrate, a gate insulation layer arranged on the backing substrate and covering the gate electrode, an active layer arranged on the gate insulation layer and located above and corresponding to the gate electrode, and a source electrode and a drain electrode arranged on the active layer and the gate insulation layer and respectively in contact engagement with two sides of the active layer; and

Step S3 further comprises a pixel electrode fabrication process, wherein the pixel electrode fabrication process is conducted before the deposition of the black light-shielding film layer and the pixel electrode fabrication process comprises: forming a via in the organic insulation layer and the protective layer to correspond to and be located above the source electrode and forming a pixel electrode on the organic insulation layer such that the pixel electrode is set in contact with the source electrode through the via.

The present invention also provides a BPS array substrate, which comprises: a backing substrate, a thin-film transistor array layer arranged on the backing substrate, a protective layer arranged on the backing substrate and covering the thin-film transistor array layer, a color resist layer arranged on the protective layer, an organic insulation layer arranged on the protective layer and covering the color resist layer, and multiple main photo spacers, multiple sub photo spacers, and a black matrix arranged on the organic insulation layer:

wherein the color resist layer comprises a plurality of color resist units arranged in an array and each of the color resist units comprises a first pixel zone, a second pixel zone, and a connection zone arranged between the first pixel zone and the second pixel zone;

the multiple main photo spacer are arranged to correspond to and located above the connection zones of multiple ones of the color resist units; the multiple sub photo spacers are arranged to correspond to and located above the connection zones of multiple ones of the color resist units; and the black matrix corresponds to spacing areas between the plurality of color resist units and a circumferential area of the plurality of color resist units; and

the main photo spacers have a height that is greater than a height of the sub photo spacers and the height of the sub photo spacers is greater than a height of the black matrix.

The connection zones have width that is smaller than widths of the first pixel zones and the second pixel zones, and a height difference between the main photo spacers and the black matrix is a thickness of the connection zones of the color resist units.

A height difference between the main photo spacers and the sub photo spacers is 0.3 μm-0.8 μm and the black matrix is formed of a material that comprises a negative photoresist material.

The thin-film transistor array layer comprises a gate electrode arranged on the backing substrate, a gate insulation layer arranged on the backing substrate and covering the gate electrode, an active layer arranged on the gate insulation layer and located above and corresponding to the gate electrode, and a source electrode and a drain electrode arranged on the active layer and the gate insulation layer and respectively in contact engagement with two sides of the active layer.

The BPS array substrate further comprises: a via formed in the organic insulation layer and the protective layer and corresponding to and located above the source electrode and a pixel electrode arranged on the organic insulation layer such that the pixel electrode is set in contact engagement with the source electrode through the via.

The present invention further provides a manufacturing method of a BPS array substrate, which comprises the following steps:

Step S1: providing a backing substrate, making a thin-film transistor array layer on the backing substrate, and forming a protective layer on the backing substrate to cover the thin-film transistor array layer;

Step S2: forming a color resist layer on the protective layer, wherein the color resist layer comprises a plurality of color resist units arranged in an array and each of the color resist units comprises a first pixel zone, a second pixel zone, and a connection zone arranged between the first pixel zone and the second pixel zone;

Step S3: forming an organic insulation layer on the protective layer to cover the color resist layer and depositing a black light-shielding film layer on the organic insulation layer,

wherein the black light-shielding film layer is formed to define multiple main photo spacer patterns corresponding to and located above the connection zones of multiple ones of the color resist units, multiple sub photo spacer patterns corresponding to and located above the connection zones of multiple ones of the color resist units, and a black matrix pattern corresponding to spacing areas between the plurality of color resist units and a circumferential area of the plurality of color resist units;

Step S4: subjecting the black light-shielding film layer to ultraviolet light exposure with one mask, wherein the mask comprises partial light transmission areas corresponding to the multiple sub photo spacer patterns and full light transmission areas corresponding to the multiple main photo spacer patterns and the black matrix pattern; and

Step S5: subjecting the black light-shielding film layer to development to form multiple main photo spacers corresponding to and located above the connection zones of multiple ones of the color resist units, multiple sub photo spacers corresponding to and located above the connection zones of multiple ones of the color resist units, and a black matrix corresponding to and located above the spacing areas between the plurality of color resist units and the circumferential area of the plurality of color resist units,

wherein the main photo spacers have a height that is greater than a height of the sub photo spacers and the height of the sub photo spacers is greater than a height of the black matrix:

wherein the connection zones have width that is smaller than widths of the first pixel zones and the second pixel zones, and a height difference between the main photo spacers and the black matrix is a thickness of the connection zones of the color resist units;

wherein a height difference between the main photo spacers and the sub photo spacers is 0.3 μm-0.8 μm and the black light-shielding film layer is formed of a material that comprises a negative photoresist material;

wherein the partial light transmission areas have a light transmission rate of 20%-40% and the full light transmission areas have a light transmission rate of 100%; and

wherein the thin-film transistor array layer comprises a gate electrode arranged on the backing substrate, a gate insulation layer arranged on the backing substrate and covering the gate electrode, an active layer arranged on the gate insulation layer and located above and corresponding to the gate electrode, and a source electrode and a drain electrode arranged on the active layer and the gate insulation layer and respectively in contact engagement with two sides of the active layer; and

Step S3 further comprises a pixel electrode fabrication process, wherein the pixel electrode fabrication process is conducted before the deposition of the black light-shielding film layer and the pixel electrode fabrication process comprises: forming a via in the organic insulation layer and the protective layer to correspond to and be located above the source electrode and forming a pixel electrode on the organic insulation layer such that the pixel electrode is set in contact with the source electrode through the via.

The efficacy of the present invention is that the present invention provides a BPS array substrate and a manufacturing method thereof. The manufacturing method of the BPS array substrate of the present invention allows a black matrix, main photo spacers, and sub photo spacers to be all arranged on an array substrate with the same manufacturing process so as to shorten the tact time, reduce manufacturing cost, and improve product competition power, wherein thicknesses of color resist units are used to achieve a height difference between the main photo spacer and the black matrix and the thicknesses of the color resist units are also used, in combination with controlling of light transmission rate of the mask, to achieve a height difference between the sub photo spacer and the black matrix so that heights of the main photo spacer and the sub photo spacer can be controlled easily. The area of the black light-shielding film layer that corresponds to and forms the black matrix corresponds to an area of a mask that is a full light transmission area during an exposure process so as to be irradiated with a sufficient amount of ultraviolet light during exposure to undergo complete crosslinking reaction, providing improved stability and being less affected by the development agent during the exposure process and being not dissolved to thereby ensure bettered consistency of film thickness of the black matrix. The BPS array substrate of the present invention allows the black matrix, the main photo spacer, and the sub photo spacer to be all arranged on the array substrate with the same manufacturing process so as to reduce manufacturing cost and improve product competition power, wherein thicknesses of color resist units are used to individually achieve a height difference between the main photo spacer and the black matrix and also used to control, to some extents, a height difference between the sub photo spacer and the black matrix so that heights of the main photo spacer and the sub photo spacer can be controlled easily. Further, the black matrix shows improved stability and bettered film thickness consistency.

For better understanding of the features and technical contents of the present invention, reference will be made to the following detailed description of the present invention and the attached drawings. However, the drawings are provided only for reference and illustration and are not intended to limit the present invention.

### BRIEF DESCRIPTION OF THE DRAWINGS

The technical solution, as well as other beneficial advantages, of the present invention will become apparent from the following detailed description of embodiments of the present invention, with reference to the attached drawings.

In the drawings:

FIG. 1 is a schematic view illustrating different levels of crosslinking reaction of a black-photo-spacer (BPS) material subjected to exposure with different light transmission rates;

FIG. 2 is a schematic view illustrating dissolution rates of a BPS material in a development process after being exposure with different light transmission rates;

FIG. 3 is a flow chart illustrating a manufacturing method of a BPS array substrate according to the present invention:

FIGS. 4 and 5 are schematic views illustrating Step S1 of the manufacturing method of the BPS array substrate according to the present invention;

FIGS. 6-8 are schematic views illustrating Step S2 of the manufacturing method of the BPS array substrate according to the present invention;

FIGS. 9 and 10 are schematic views illustrating Step S3 of the manufacturing method of the BPS array substrate according to the present invention;

FIG. 11 is a schematic view illustrating Step S4 of the manufacturing method of the BPS array substrate according to the present invention; and

FIGS. 12-14 are schematic views illustrating Step S5 of the manufacturing method of the BPS array substrate according to the present invention and are also schematic views illustrating the structure of the BPS array substrate according to the present invention.

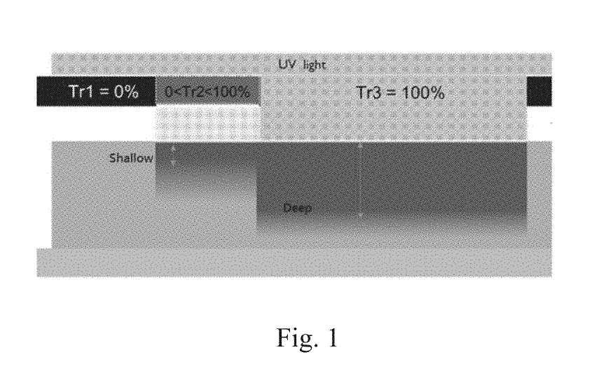

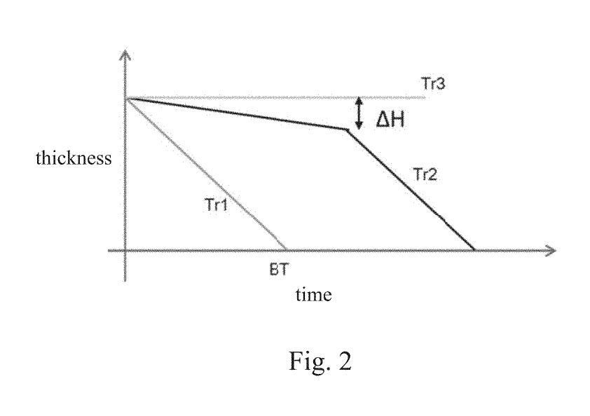

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

The present invention provides an inventive idea of combining black-photo-space (BPS) technology and color-filter-on-array (COA) technology so that not only the black matrix 83, the main photo spacer 81, and the sub photo spacer 82 are all formed on an array substrate, but a color resist layer 40 is also formed on the array substrate, wherein a height of color resist units 41 is used to achieve a height difference between the main photo spacer 81 and the black matrix 83 and a thickness of the color resist units 41 are used, in combination controlling of a light transmission rate of a mask 70, to achieve a height difference between the sub photo spacer 82 and the black matrix 83.

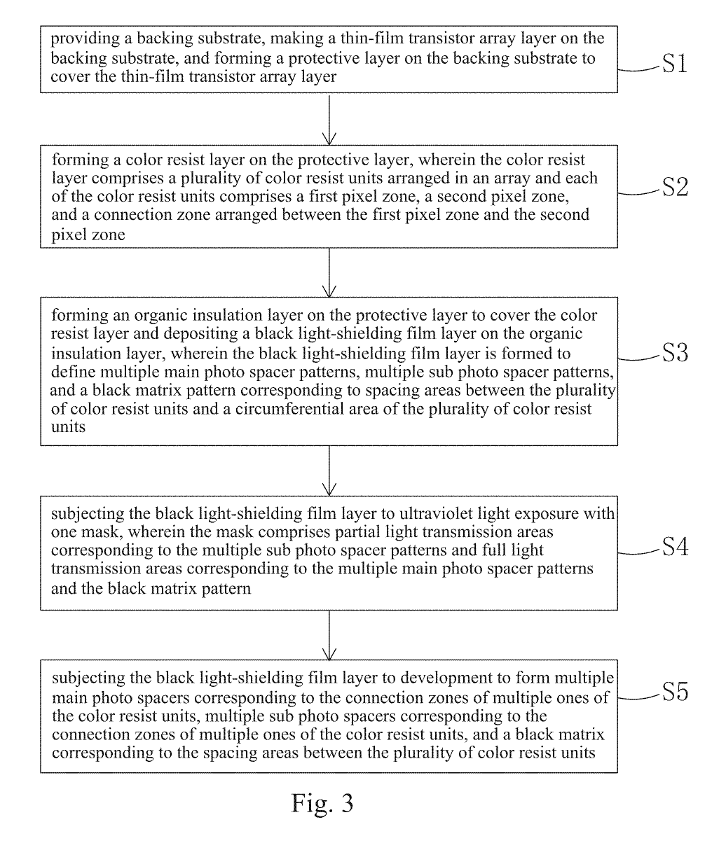

Referring to FIG. 3, the present invention provides a manufacturing method of a BPS array substrate, which comprises the following steps:

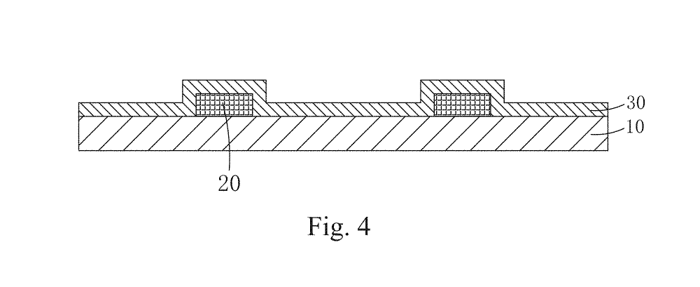

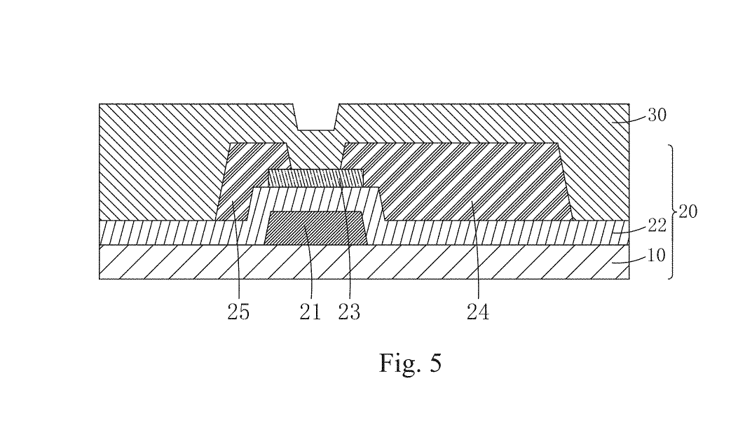

Step S1: as shown in FIGS. 4 and 5, providing a backing substrate 10, making a thin-film transistor array layer 20 on the backing substrate 10, and forming a protective layer 30 on the backing substrate 10 to cover the thin-film transistor array layer 20.

Specifically, as shown in FIG. 5, the thin-film transistor array layer 20 comprises a gate electrode 21 arranged on the backing substrate 10, a gate insulation layer 22 arranged on the backing substrate 10 and covering the gate electrode 21, an active layer 23 arranged on the gate insulation layer 22 and located above and corresponding to the gate electrode 21, and a source electrode 24 and a drain electrode 25 arranged on the active layer 23 and the gate insulation layer 22 and respectively in contact engagement with two sides of the active layer 23.

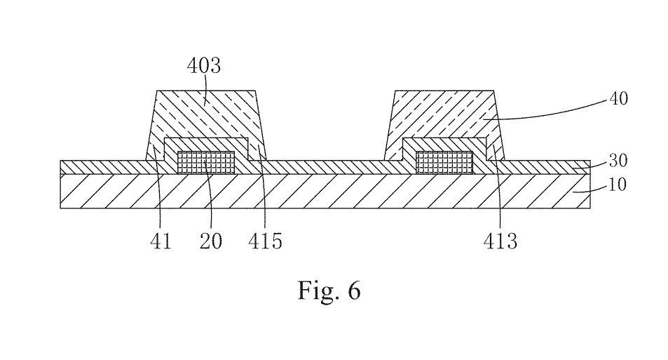

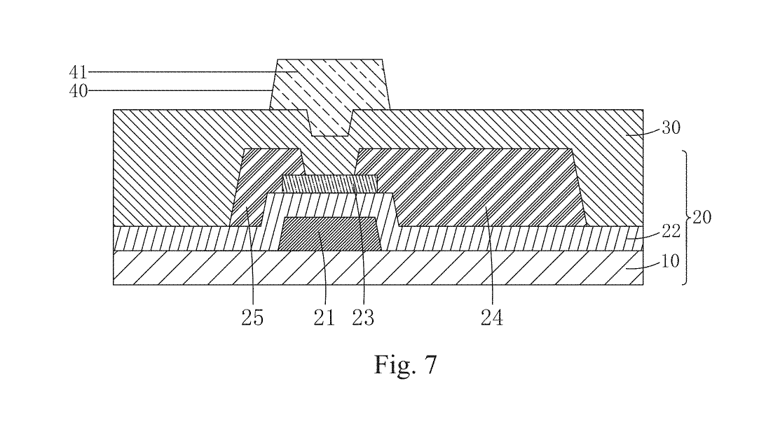

Step S2: as shown in FIGS. 6-8, forming a color resist layer 40 on the protective layer 30, wherein the color resist layer 40 comprises a plurality of color resist units 41 arranged in an array and each of the color resist units 41 comprises a first pixel zone 401, a second pixel zone 402, and a connection zone 403 arranged between the first pixel zone 401 and the second pixel zone 402.

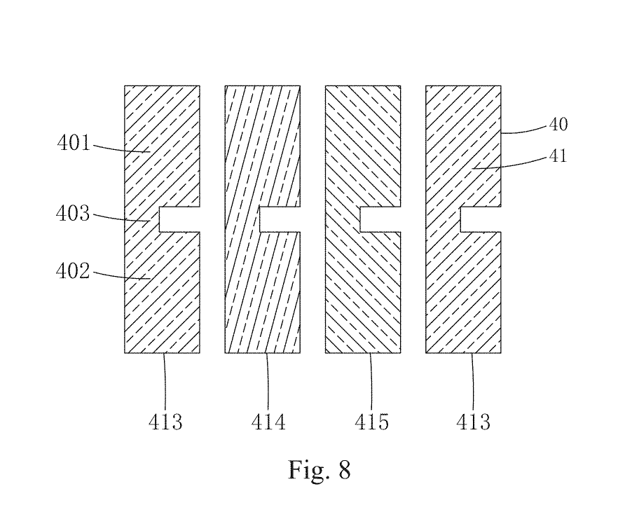

Specifically, as shown in FIG. 8, the connection zone 403 has a width that is smaller than widths of the first pixel zone 401 and the second pixel zone 402.

Specifically, as shown in FIG. 8, the plurality of color resist units 41 comprise a plurality of red color resist units 413, a plurality of green color resist units 414, and a plurality of blue color resist units 415.

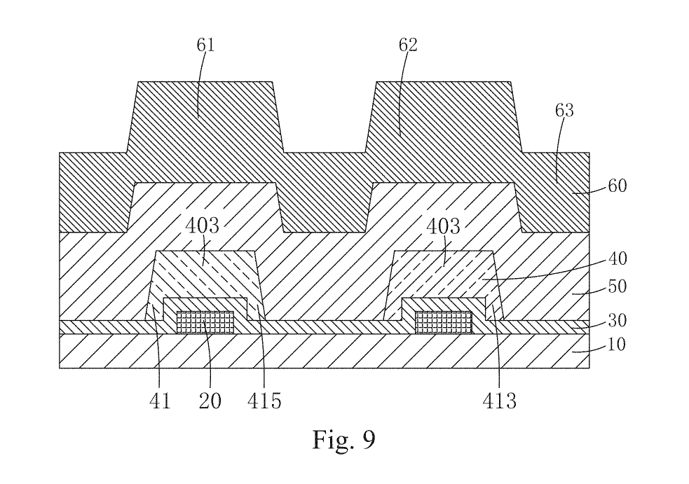

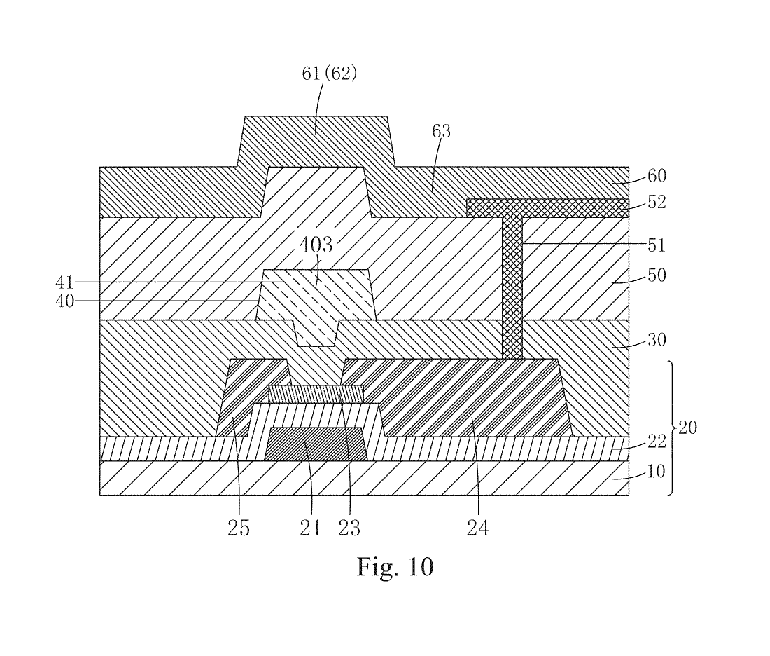

Step S3: as shown in FIGS. 9 and 10, forming an organic insulation layer 50 on the protective layer 30 to cover the color resist layer 40 and depositing a black light-shielding film layer 60 on the organic insulation layer 50,

wherein the black light-shielding film layer 60 is formed to define multiple main photo spacer patterns 61 corresponding to and located above the connection zones 403 of multiple ones of the color resist units 41, multiple sub photo spacer patterns 62 corresponding to and located above the connection zones 403 of multiple ones of the color resist units 41, and a black matrix pattern 63 corresponding to spacing areas between the plurality of color resist units 41 and a circumferential area of the plurality of color resist units 41.

Specifically, the black light-shielding film layer 60 is formed of a material that comprises a negative photoresist material.

Specifically, as shown in FIG. 10, Step S3 further includes a pixel electrode fabrication process, wherein the pixel electrode fabrication process is conducted before the deposition of the black light-shielding film layer 60 and the pixel electrode fabrication process comprises: forming a via 51 in the organic insulation layer 50 and the protective layer 30 to correspond to and be located above the source electrode 24 and forming a pixel electrode 52 on the organic insulation layer 50 such that the pixel electrode 52 is set in contact with the source electrode 24 through the via 51.

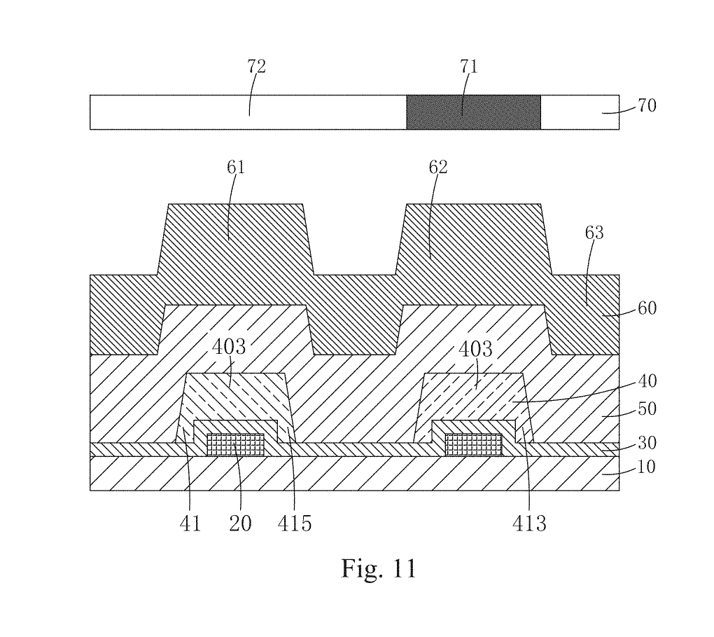

Step S4: as shown in FIG. 11, subjecting the black light-shielding film layer 60 to ultraviolet light exposure with one mask 70, wherein the mask 70 comprises partial light transmission areas 71 corresponding to the multiple sub photo spacer patterns 62 and full light transmission areas 72 corresponding to the multiple main photo spacer patterns 61 and the black matrix pattern 63.

Specifically, in Step S4, areas of the black light-shielding film layer 60 that correspond to the full light transmission areas 72 undergo complete crosslinking reaction under the irradiation of ultraviolet light, and areas of the black light-shielding film layer 60 that correspond to the partial light transmission areas 71 undergo reduced crosslinking reaction under the irradiation of ultraviolet light.

Specifically, the partial light transmission areas 71 have a light transmission rate that is 0-100%, preferably 20%-40%, and the full light transmission areas 72 have a light transmission rate that is 100%.

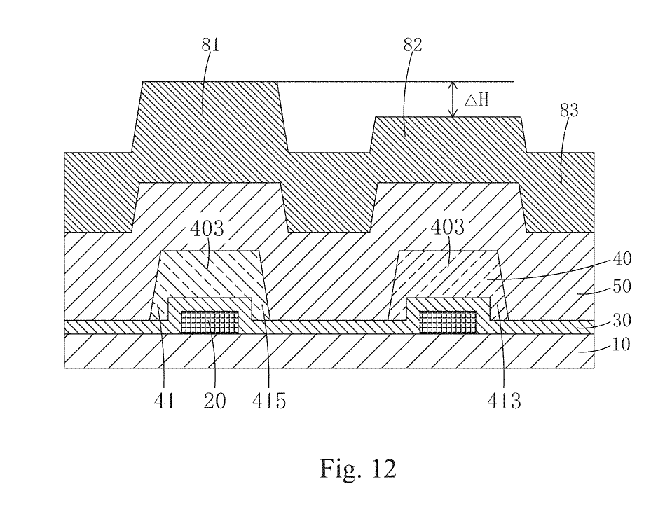

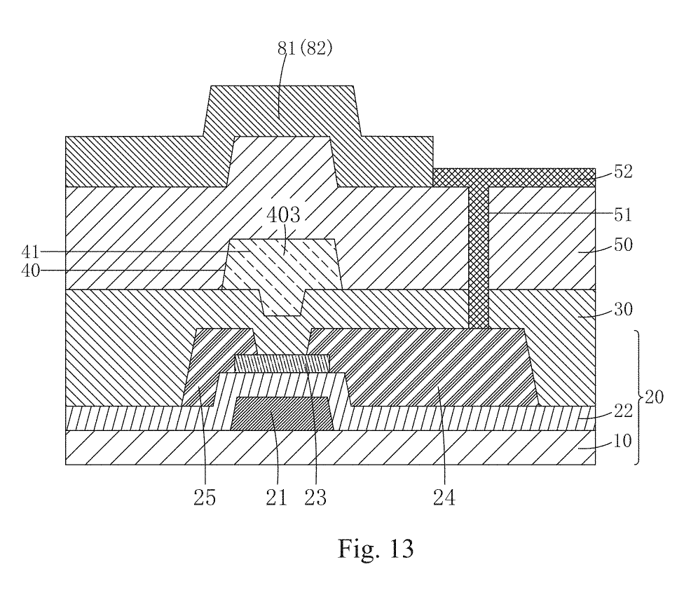

Step S5: as shown in FIGS. 12-14, subjecting the black light-shielding film layer 60 to development to form multiple main photo spacers 81 corresponding to and located above the connection zones 403 of multiple ones of the color resist units 41, multiple sub photo spacers 82 corresponding to and located above the connection zones 403 of multiple ones of the color resist units 41, and a black matrix 83 corresponding to and located above the spacing areas between the plurality of color resist units 41 and the circumferential area of the plurality of color resist units 41,

wherein the main photo spacers 81 have a height that is greater than a height of the sub photo spacers 82 and the height of the sub photo spacers 82 is greater than a height of the black matrix 83.

Specifically, a height difference between the main photo spacers 81 and the black matrix 83 is a thickness of the connection zones 403 of the color resist units 41.

Specifically, a height difference between the main photo spacers 81 and the sub photo spacers 82 is 0.3 μm-0.8 μm, preferably 0.4 μm-0.6 μm.

Specifically, during the development process, the areas of the black light-shielding film layer 60 that correspond to the full light transmission areas 72, due to undergoing complete crosslinking reaction, are not dissolved with a development agent and thus form the main photo spacer 81 and the black matrix 83; and areas of the black light-shielding film layer 60 that correspond to the partial light transmission areas 71, due to undergoing reduced crosslinking reaction, would be partly dissolved with the development agent so as to form the sub photo spacers 82.

During the development process, for the areas of the black light-shielding film layer 60 that correspond to and form the sub photo spacers 82, a portion that is dissolved is an upper, surface layer of the black light-shielding film layer 60, where the reduced crosslinking reaction occurs and such a reduced crosslinking reaction shows a reduced rate of dissolution so as to provide bettered stability.

Specifically, by using the BPS array substrate manufactured with the present invention in a liquid crystal display panel, the main photo spacers 81 and the sub photo spacers 82 provide an effect of support liquid crystal cell thickness, while the black matrix 83 provides an effect of light shielding to prevent color mixture resulting from the red, green, and blue color resist.

In the known BPS techniques, a mask area having a light transmission rate of 10%-30% is used to subject an area of a BPS material that corresponds to and forms a black matrix to exposure. Since crosslinking reaction occurring in such a portion of the material is incomplete, influence caused by all sorts of factors of the surrounding environment during a development process may readily occurs, leading to poor consistency of film thickness of the black matrix. In this application, an area of the black light-shielding film layer 60 that corresponds to and forms a black matrix 83 corresponds to an area of a mask that is a full light transmission area 72 during an exposure process so that due to receiving a sufficient amount of ultraviolet light irradiation in the exposure process, crosslinking reaction is complete and the stability is high and is less affected by the development agent during the exposure process and would not be dissolved to thereby ensure bettered consistency of film thickness of the black matrix 83.

The manufacturing method of the BPS array substrate according to the present invention allows a black matrix 83, main photo spacers 81, and sub photo spacers 82 to be all arranged on an array substrate with the same manufacturing process so as to shorten the tact time, reduce manufacturing cost, and improve product competition power, wherein thicknesses of color resist units 41 are used to achieve a height difference between the main photo spacer 81 and the black matrix 83 and the thicknesses of the color resist units 41 are also used, in combination with controlling of light transmission rate of the mask 70, to achieve a height difference between the sub photo spacer 82 and the black matrix 83 so that heights of the main photo spacer 81 and the sub photo spacer 82 can be controlled easily. The area of the black light-shielding film layer 60 that corresponds to and forms the black matrix 83 corresponds to an area of a mask that is a full light transmission area 72 during an exposure process so as to be irradiated with a sufficient amount of ultraviolet light during exposure to undergo complete crosslinking reaction, providing improved stability and being less affected by the development agent during the exposure process and being not dissolved to thereby ensure bettered consistency of film thickness of the black matrix 83.

Referring to FIGS. 12-14, in combination with FIG. 8, based on the above-described manufacturing method of a BPS array substrate, the present invention also provides a BPS array substrate, which comprises: a backing substrate 10, a thin-film transistor array layer 20 arranged on the backing substrate 10, a protective layer 30 arranged on the backing substrate 10 and covering the thin-film transistor array layer 20, a color resist layer 40 arranged on the protective layer 30, an organic insulation layer 50 arranged on the protective layer 30 an covering the color resist layer 40, and multiple main photo spacers 81, multiple sub photo spacers 82, and a black matrix 83 arranged on the organic insulation layer 50.

As shown in FIG. 8, the color resist layer 40 comprises a plurality of color resist units 41 arranged in an array and each of the color resist units 41 comprises a first pixel zone 401, a second pixel zone 402, and a connection zone 403 arranged between the first pixel zone 401 and the second pixel zone 402.

The multiple main photo spacers 81 are arranged to correspond to and located above the connection zones 403 of multiple ones of the color resist units 41. The multiple sub photo spacers 82 are arranged to correspond to and located above the connection zones 403 of multiple ones of the color resist units 41. The black matrix 83 corresponds to spacing areas between the plurality of color resist units 41 and a circumferential area of the plurality of color resist units 41.

The main photo spacers 81 have a height that is greater than a height of the sub photo spacers 82 and the height of the sub photo spacers 82 is greater than a height of the black matrix 83.

Specifically, as shown in FIG. 8, the connection zones 403 have a width that is smaller than widths of the first pixel zones 401 and the second pixel zones 402.

Specifically, the black matrix 83 is formed of a material that comprises a negative photoresist material.

Specifically, a height difference between the main photo spacers 81 and the black matrix 83 is a thickness of the connection zones 403 of the color resist units 41.

Specifically, a height difference between the main photo spacers 81 and the sub photo spacers 82 is 0.3 μm-0.8 μm, preferably 0.4 μm-0.6 μm.

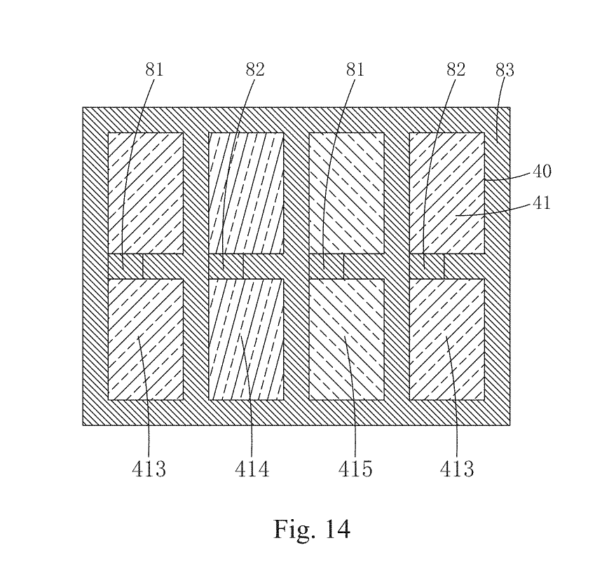

Specifically, as shown in FIG. 14, the plurality of color resist units 41 comprises a plurality of red color resist units 413, a plurality of green color resist units 414, and a plurality of blue color resist units 415.

Specifically, the thin-film transistor array layer 20 comprises a gate electrode 21 arranged on the backing substrate 10, a gate insulation layer 22 arranged on the backing substrate 10 and covering the gate electrode 21, an active layer 23 arranged on the gate insulation layer 22 and located above and corresponding to the gate electrode 21, and a source electrode 24 and a drain electrode 25 arranged on the active layer 23 and the gate insulation layer 22 and respectively in contact engagement with two sides of the active layer 23.

Specifically, the BPS array substrate of the present invention further comprises: a via 51 formed in the organic insulation layer 50 and the protective layer 30 and corresponding to and located above the source electrode 24 and a pixel electrode 52 arranged on the organic insulation layer 50, such that the pixel electrode 52 is set in contact engagement with the source electrode 24 through the via 51.

Compared to the known liquid crystal display technology, the present invention provides an arrangement in which the black matrix (BM), the photo spacers (PS), and color resist of red, green, and blue colors are all arranged on the array-substrate side, while an upper substrate that is arranged opposite to the array substrate is provided with a transparent oxide (ITO) electrode only. This prevents light leaking resulting from accuracy error of assembling during an assembling process or translation occurring in bending a panel in the curved display technology, and more importantly, may save one material and one operation so as to shorten tact time and reduce manufacturing cost.

The BPS array substrate of the present invention allows the black matrix 83, the main photo spacer 81, and the sub photo spacer 82 to be all arranged on the array substrate with the same manufacturing process so as to reduce manufacturing cost and improve product competition power, wherein thicknesses of color resist units 41 are used to individually achieve a height difference between the main photo spacer 81 and the black matrix 83 and also used to control, to some extents, a height difference between the sub photo spacer 82 and the black matrix 83 so that heights of the main photo spacer 81 and the sub photo spacer 82 can be controlled easily. Further, the black matrix 83 shows improved stability and bettered film thickness consistency.

In summary, the present invention provides a BPS array substrate and a manufacturing method thereof. The manufacturing method of the BPS array substrate of the present invention allows a black matrix, main photo spacers, and sub photo spacers to be all arranged on an array substrate with the same manufacturing process so as to shorten the tact time, reduce manufacturing cost, and improve product competition power, wherein thicknesses of color resist units are used to achieve a height difference between the main photo spacer and the black matrix and the thicknesses of the color resist units are also used, in combination with controlling of light transmission rate of the mask, to achieve a height difference between the sub photo spacer and the black matrix so that heights of the main photo spacer and the sub photo spacer can be controlled easily. The area of the black light-shielding film layer that corresponds to and forms the black matrix corresponds to an area of a mask that is a full light transmission area during an exposure process so as to be irradiated with a sufficient amount of ultraviolet light during exposure to undergo complete crosslinking reaction, providing improved stability and being less affected by the development agent during the exposure process and being not dissolved to thereby ensure bettered consistency of film thickness of the black matrix. The BPS array substrate of the present invention allows the black matrix, the main photo spacer, and the sub photo spacer to be all arranged on the array substrate with the same manufacturing process so as to reduce manufacturing cost and improve product competition power, wherein thicknesses of color resist units are used to individually achieve a height difference between the main photo spacer and the black matrix and also used to control, to some extents, a height difference between the sub photo spacer and the black matrix so that heights of the main photo spacer and the sub photo spacer can be controlled easily. Further, the black matrix shows improved stability and bettered film thickness consistency.

Based on the description given above, those having ordinary skills in the art may easily contemplate various changes and modifications of the technical solution and the technical ideas of the present invention. All these changes and modifications are considered belonging to the protection scope of the present invention as defined in the appended claims.

What is claimed is:

1. A manufacturing method of a black-photo-spacer (BPS) array substrate, comprising the following steps:
Step S1: providing a backing substrate, making a thin-film transistor array layer on the backing substrate, and forming a protective layer on the backing substrate to cover the thin-film transistor array layer;
Step S2: forming a color resist layer on the protective layer, wherein the color resist layer comprises a plurality of color resist units arranged in an array and each of the color resist units comprises a first pixel zone, a second pixel zone, and a connection zone arranged between the first pixel zone and the second pixel zone;
Step S3: forming an organic insulation layer on the protective layer to cover the color resist layer and depositing a black light-shielding film layer on the organic insulation layer,
wherein the black light-shielding film layer is formed to define multiple main photo spacer patterns corresponding to and located above the connection zones of multiple ones of the color resist units, multiple sub photo spacer patterns corresponding to and located above the connection zones of multiple ones of the color resist units, and a black matrix pattern corresponding to spacing areas between the plurality of color resist units and a circumferential area of the plurality of color resist units;
Step S4: subjecting the black light-shielding film layer to ultraviolet light exposure with one mask, wherein the mask comprises partial light transmission areas corresponding to the multiple sub photo spacer patterns and full light transmission areas corresponding to the multiple main photo spacer patterns and the black matrix pattern; and
Step S5: subjecting the black light-shielding film layer to development to form multiple main photo spacers corresponding to and located above the connection zones of multiple ones of the color resist units, multiple sub photo spacers corresponding to and located above the connection zones of multiple ones of the color resist units, and a black matrix corresponding to and located above the spacing areas between the plurality of color resist units and the circumferential area of the plurality of color resist units,
wherein the main photo spacers have a height that is greater than a height of the sub photo spacers and the height of the sub photo spacers is greater than a height of the black matrix.

2. The manufacturing method of the BPS array substrate as claimed in claim 1, wherein the connection zones have width that is smaller than widths of the first pixel zones and the second pixel zones, and a height difference between the main photo spacers and the black matrix is a thickness of the connection zones of the color resist units.

3. The manufacturing method of the BPS array substrate as claimed in claim 1, wherein a height difference between the main photo spacers and the sub photo spacers is 0.3 μm-0.8 μm and the black light-shielding film layer is formed of a material that comprises a negative photoresist material.

4. The manufacturing method of the BPS array substrate as claimed in claim 1, wherein the partial light transmission areas have a light transmission rate of 20-40% and the full light transmission areas have a light transmission rate of 100%.

5. The manufacturing method of the BPS array substrate as claimed in claim 1, wherein the thin-film transistor array layer comprises a gate electrode arranged on the backing substrate, a gate insulation layer arranged on the backing substrate and covering the gate electrode, an active layer arranged on the gate insulation layer and located above and corresponding to the gate electrode, and a source electrode and a drain electrode arranged on the active layer and the gate insulation layer and respectively in contact engagement with two sides of the active layer; and
Step S3 further comprises a pixel electrode fabrication process, wherein the pixel electrode fabrication process is conducted before the deposition of the black light-shielding film layer and the pixel electrode fabrication process comprises: forming a via in the organic insulation layer and the protective layer to correspond to and be located above the source electrode and forming a pixel electrode on the organic insulation layer such that the pixel electrode is set in contact with the source electrode through the via.

6. A black-photo-spacer (BPS) array substrate, comprising: a backing substrate, a thin-film transistor array layer arranged on the backing substrate, a protective layer arranged on the backing substrate and covering the thin-film transistor array layer, a color resist layer arranged on the protective layer, an organic insulation layer arranged on the protective layer and covering the color resist layer, and multiple main photo spacers, multiple sub photo spacers, and a black matrix arranged on the organic insulation layer:
wherein the color resist layer comprises a plurality of color resist units arranged in an array and each of the color resist units comprises a first pixel zone, a second pixel zone, and a connection zone arranged between the first pixel zone and the second pixel zone;
the multiple main photo spacer are arranged to correspond to and located above the connection zones of multiple ones of the color resist units; the multiple sub photo spacers are arranged to correspond to and located above the connection zones of multiple ones of the color resist units; and the black matrix corresponds to spacing areas between the plurality of color resist units and a circumferential area of the plurality of color resist units; and
the main photo spacers have a height that is greater than a height of the sub photo spacers and the height of the sub photo spacers is greater than a height of the black matrix.

7. The BPS array substrate as claimed in claim 6, wherein the connection zones have width that is smaller than widths of the first pixel zones and the second pixel zones, and a height difference between the main photo spacers and the black matrix is a thickness of the connection zones of the color resist units.

8. The BPS array substrate as claimed in claim 6, wherein a height difference between the main photo spacers and the sub photo spacers is 0.3 μm-0.8 μm and the black matrix is formed of a material that comprises a negative photoresist material.

9. The BPS array substrate as claimed in claim 6, wherein the thin-film transistor array layer comprises a gate electrode arranged on the backing substrate, a gate insulation layer arranged on the backing substrate and covering the gate electrode, an active layer arranged on the gate insulation layer and located above and corresponding to the gate electrode, and a source electrode and a drain electrode arranged on the active layer and the gate insulation layer and respectively in contact engagement with two sides of the active layer.

10. The BPS array substrate as claimed in claim 9, wherein the BPS array substrate further comprises: a via formed in the organic insulation layer and the protective layer and corresponding to and located above the source electrode and a pixel electrode arranged on the organic insulation layer such that the pixel electrode is set in contact engagement with the source electrode through the via.

11. A manufacturing method of a black-photo-spacer (BPS) array substrate, comprising the following steps:
Step S1: providing a backing substrate, making a thin-film transistor array layer on the backing substrate, and forming a protective layer on the backing substrate to cover the thin-film transistor array layer;
Step S2: forming a color resist layer on the protective layer, wherein the color resist layer comprises a plurality of color resist units arranged in an array and each of the color resist units comprises a first pixel zone, a second pixel zone, and a connection zone arranged between the first pixel zone and the second pixel zone;
Step S3: forming an organic insulation layer on the protective layer to cover the color resist layer and depositing a black light-shielding film layer on the organic insulation layer,
wherein the black light-shielding film layer is formed to define multiple main photo spacer patterns corresponding to and located above the connection zones of multiple ones of the color resist units, multiple sub photo spacer patterns corresponding to and located above the connection zones of multiple ones of the color resist units, and a black matrix pattern corresponding to spacing areas between the plurality of color resist units and a circumferential area of the plurality of color resist units;
Step S4: subjecting the black light-shielding film layer to ultraviolet light exposure with one mask, wherein the mask comprises partial light transmission areas corresponding to the multiple sub photo spacer patterns and full light transmission areas corresponding to the multiple main photo spacer patterns and the black matrix pattern; and
Step S5: subjecting the black light-shielding film layer to development to form multiple main photo spacers corresponding to and located above the connection zones of multiple ones of the color resist units, multiple sub photo spacers corresponding to and located above the connection zones of multiple ones of the color resist units, and a black matrix corresponding to and located above the spacing areas between the plurality of color resist units and the circumferential area of the plurality of color resist units,
wherein the main photo spacers have a height that is greater than a height of the sub photo spacers and the height of the sub photo spacers is greater than a height of the black matrix;
wherein the connection zones have width that is smaller than widths of the first pixel zones and the second pixel zones, and a height difference between the main photo spacers and the black matrix is a thickness of the connection zones of the color resist units;
wherein a height difference between the main photo spacers and the sub photo spacers is 0.3 μm-0.8 μm and the black light-shielding film layer is formed of a material that comprises a negative photoresist material;
wherein the partial light transmission areas have a light transmission rate of 20%-40% and the full light transmission areas have a light transmission rate of 100%; and
wherein the thin-film transistor array layer comprises a gate electrode arranged on the backing substrate, a gate insulation layer arranged on the backing substrate and covering the gate electrode, an active layer arranged on the gate insulation layer and located above and corresponding to the gate electrode, and a source electrode and a drain electrode arranged on the active layer and the gate insulation layer and respectively in contact engagement with two sides of the active layer; and
Step S3 further comprises a pixel electrode fabrication process, wherein the pixel electrode fabrication process is conducted before the deposition of the black light-shielding film layer and the pixel electrode fabrication process comprises: forming a via in the organic insulation layer and the protective layer to correspond to and be located above the source electrode and forming a pixel electrode on the organic insulation layer such that the pixel electrode is set in contact with the source electrode through the via.
